(19) United States
(12) Patent Application Publication
(10) Pub. No.: US 2002/0191277 A1
(43) Pub. Date: Dec. 19, 2002

(54) Method and apparatus for amplifying an optical signal

(75) Inventors: Yihong Chen, Marlboro, NJ (US); Leda M. Lunardi, Marlboro, NJ (US)

Correspondence Address: Hall, Priddy, Myers & Vande Sande, Suite 200, 10220 River Road, Potomac, MD, 20854, US

(73) Assignee: JDS Uniphase Corporation

(21) Appl. No.: 09/879,925

(22) Filed: Jun. 14, 2001

(51) Int. Cl. H01S 3/00

(52) U.S. Cl. 359/341.4; 359/334

(57) ABSTRACT

A method and apparatus for amplifying an optical signal includes an amplification scheme that combines Raman amplification (RA) with a semiconductor optical amplifier (SOA) to achieve a wider bandwidth, flatter gain spectrum, and higher gain than either RA or SOA is able to achieve independently. The SOA is typically a conventional SOA selected to have a negatively sloped response, whereas the RA stage typically includes a distributed Raman amplifier pumped with a wavelength and power so as to have a positively sloped response. In the preferred embodiment, SOA precedes the RA stage to improve the signal-to-noise ratio.

### FIELD OF THE INVENTION

The present application relates to a method and apparatus for amplifying an optical signal, and in particular, for amplifying an optical signal using a semiconductor optical and Raman hybrid amplifier.

### BACKGROUND OF THE INVENTION

Wavelength division multiplexing (WDM) has been used to increase the capacity of existing fiber optic networks. In a WDM system, a plurality of optical signal channels are carried over a single optical fiber with each channel being assigned a particular wavelength.

Optical channels in a WDM system are frequently transmitted over silica based optical fibers, which typically have relatively low loss at wavelengths from about 1525 nm to 1565 (e.g., the C band) and/or from about 1570-1625 nm (e.g., the L band). Less commonly, the optical channels are transmitted at wavelengths from about 1325-1365 nm (e.g., the S band). WDM optical channels at wavelengths within these low loss windows can be transmitted over distances of approximately 50 km without significant attenuation. For distances beyond 50 km, however, optical amplifiers are required to compensate for optical fiber loss.

In dense wavelength division multiplexing (DWDM) systems, the optical amplifier should provide uniform amplification or gain at wavelengths over the entire low loss window of the optical fiber. Moreover, these optical amplifiers should provide good-signal-to noise ratios and limit cross-talk between channels.

The most widely used optical amplifiers in DWDM systems are erbium doped fibre amplifiers (EDFAs). EDFAs include an erbium-doped fiber for transmitting the DWDM optical signal and a light source for pumping the erbium-doped fibre. Advantageously, EDFAs provide a relatively high gain, low cross-talk between channels, and good saturation output power. Disadvantageously, EDFAs have a high cost, are temperature sensitive, and are generally limited to the 1525 to 1565 nm (C-band) and the 1570 nm to 1625 nm (L-band) spectral regions. Moreover, the gain is not uniform across the entire C band. For example, an optical channel at a wavelength of 1540 nm is typically amplified 4 dB more than an optical channel at a wavelength of 1555 nm. While such a large variation in gain may be tolerated for a system with only one optical amplifier, it cannot be tolerated for a system with a plurality of optical amplifiers. As a result, EDFAs are frequently used with expensive gain equalizers or gain flatteners to flatten the gain spectrum.

Another type of optical amplifier is a semiconductor optical amplifier (SOA). SOAs rely on electrical, rather than optical, pump sources for amplification. More specifically, they have a structure that is essentially the same as a semiconductor laser with the exception that the input/outputs include anti-reflecting coatings to reduce light reflection and resonance therein. Traditionally, SOAs have not challenged the role of EDFAs in WDM telecommunication systems in view of their relatively low gain, relatively low signal-to-noise ratio, and tilted gain spectrum. However, SOAs do have the advantage of using a smaller amount of electric power, and of being more compact, less temperature sensitive, more simple, and less expensive than EDFAs. Moreover, they can amplify light over a range of wavelengths include those in the S, C and L bands. Accordingly, SOAs show great potential in many applications.

A third type of optical amplifier is a Raman optical amplifier (ROA). In ROAs light traveling within a gain medium is amplified by the presence of lower wavelength pump light traveling within the same medium, via stimulated Raman scattering. ROAs can be categorized as either distributed or discrete. In distributed amplifiers, the transmission fiber itself is used as the gain medium. In discrete amplifiers, a separate fiber, typically optimized for Raman amplification, is used as the gain medium. Advantageously, ROAs are readily incorporated into existing DWDM systems, are capable of operating over the S, C and L bands when pumped at correspondent various wavelengths. In fact, Raman amplifiers have the advantage that the gain shape and spectral width are controlled by appropriate choice of pump wavelength and pump power at a given wavelength. Furthermore, ROAs provide increased signal-to-noise ratios over SOAs. Disadvantageously, ROAs are also associated with a relatively low gain and a tilted gain spectrum.

It is an object of the instant invention to provide a method and apparatus that combines advantages of SOAs and ROAs.

It is another object of the instant invention to provide a method and apparatus that provides a wider bandwidth, flatter gain spectrum, and higher gain than either conventional SOAs or ROAs.

### SUMMARY OF THE INVENTION

The instant invention provides a method and apparatus for amplifying an optical signal combines Raman amplification (RA) with amplification from semiconductor optical amplifier (SOA) to achieve a wider bandwidth, flatter gain spectrum, and higher gain than either RA or SOA is able to achieve independently.

More specifically, the instant invention provides a hybrid optical amplifier scheme based on Raman amplification and a SOA, which has relatively flat gain characteristics over the entire C-band. The SOA is typically a conventional SOA selected to have a negatively sloped response within the C-band, whereas the RA stage typically includes a distributed Raman amplifier pumped with a wavelength and power so as to have a positively sloped response in the C-band. In the preferred embodiment, the SOA is upstream from the RA stage.

In accordance with the instant invention there is provided a method of amplifying an optical signal comprising the steps of: launching the optical signal into an input port of a semiconductor optical amplifier such that an amplified output optical signal having a spectrum with a substantially negative slope within a predetermined wavelength range is produced at an output port of the semiconductor optical amplifier; and pumping the amplified output optical signal with a wavelength and power sufficient to further amplify the amplified output signal via stimulated Raman scattering to produce a further amplified output optical signal having a substantially flat spectrum within the predetermined wavelength range.

In accordance with the instant invention there is provided a method of amplifying an optical signal comprising the steps of: launching the optical signal along an optical fibre; pumping the optical signal with a wavelength and a power sufficient to amplify the optical signal via stimulated Raman scattering to produce an amplified output optical signal having a spectrum with a substantially positive slope within a predetermined wavelength range; and, launching the amplified output optical signal into an input port of a semiconductor optical amplifier such that a further amplified output optical signal is produced at an output port of the semiconductor optical amplifier having a substantially flat spectrum within the predetermined wavelength range.

In accordance with the instant invention there is further provided an apparatus for amplifying an optical signal comprising: a semiconductor optical amplifier for producing an output optical signal having a substantially negatively sloped spectrum in response to an input optical signal having a substantially flat input spectrum; and a Raman amplifier for producing another output optical signal having a substantially positively sloped spectrum in response to the input optical signal having the substantially flat input spectrum.

### BRIEF DESCRIPTION OF THE DRAWINGS

Exemplary embodiments of the invention will now be described in conjunction with the drawings, in which:

FIG. 1 is a schematic diagram of one embodiment of the instant invention, wherein a SOA is followed with Raman amplification;

FIG. 2 is a schematic diagram of another embodiment of the instant invention, wherein Raman amplification is followed with a SOA;

FIG. 3 is a plot of gain versus wavelength for the individual Raman amplification and SOA amplification stages shown in FIGS. 1 and 2, for various SOA input powers;

FIG. 4 is a plot of output intensity versus wavelength for the embodiment illustrated in FIG. 1; and

FIG. 5 is a plot of output intensity versus wavelength for the embodiment illustrated in FIG. 2.

It will be noted that throughout the appended drawings, like features are identified by like reference numerals.

### DETAILED DESCRIPTION

The present invention provides an amplification scheme that combines Raman amplification (RA) with a semiconductor optical amplifier (SOA) to achieve a wider bandwidth, flatter gain spectrum, and higher gain than either RA or SOA is able to achieve independently.

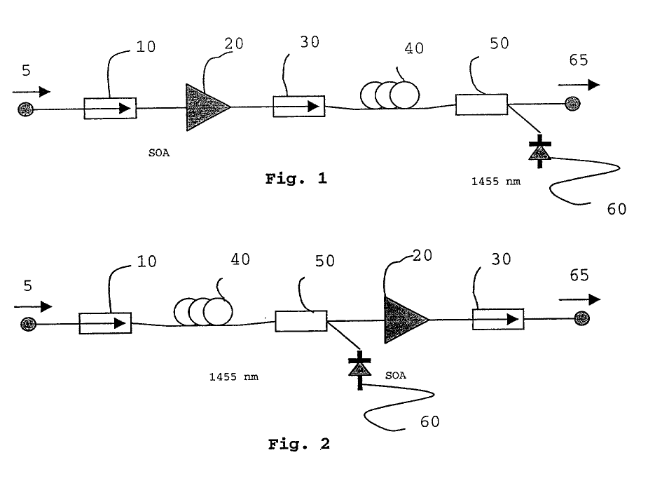

Referring to FIG. 1, there is shown an embodiment of amplifying scheme in accordance with the instant invention, wherein a SOA is followed by a Raman amplifying stage. The SOA 20 is shown as a conventional SOA using semiconductor technology, which is sandwiched between first 10 and second 20 optical isolators. The subsequent Raman amplifying stage includes a length of transmission fibre 40, a wavelength division multiplexor (WDM) 50, and a single pump source 60. The first isolator 10 stops backreflections from the SOA from reaching the input source, while the second isolator 30 stops backreflections and pump light from reaching the SOA 20.

In operation, an input optical signal 5 is launched into the amplifier, is passed through the first isolator 10, is amplified with the SOA 20, passes through the second isolator 30, and propagates along the transmission fibre 40 as an amplified optical signal. Simultaneously, pump light from pump source 60 is directed into the transmission fibre 40 via WDM 50 in a counter-propagating direction. Since the pump light has a lower wavelength (e.g., 1455 nm) than the optical signal (e.g., 1530-1560 nm) the optical signal is further amplified via stimulated Raman scattering to produce a twice amplified output optical signal 65.

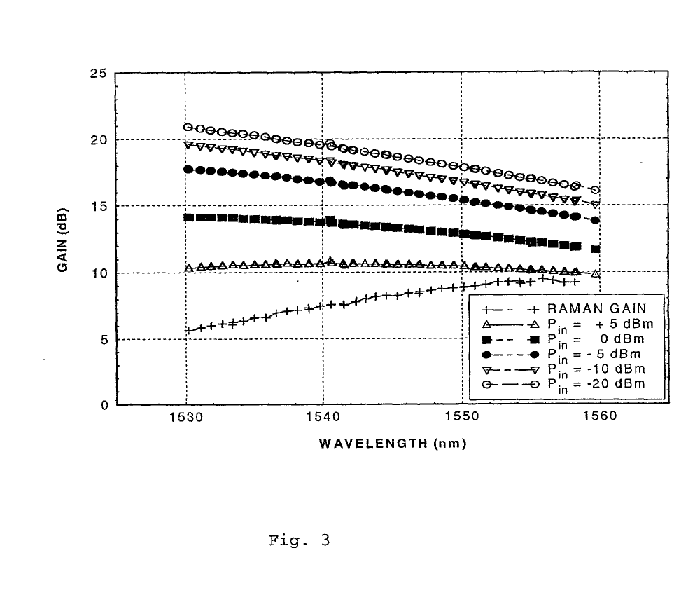

Referring to FIG. 2, there is shown another embodiment of amplifying scheme in accordance with the instant invention, wherein a Raman amplifying stage is followed by a SOA. The Raman amplifying stage includes a length of transmission fibre 40, a wavelength division multiplexor (WDM) 50, and a single pump source 60. The SOA 20 is a conventional SOA using semiconductor technology. A first isolator 10 stops backreflections from the Raman amplifying stage and the SOA, and pump light from the Raman source 60, from reaching the input source, while the second isolator 30 stops backreflections from reaching the SOA 20.

In operation, an input optical signal 5 is launched into the amplifier, is passed through the first isolator 10 and propagates along the transmission fibre 40. Simultaneously, pump light from pump source 60 is directed into the transmission fibre 40 via WDM 50 in a counter-propagating direction. Since the pump light has a lower wavelength (e.g., 1455 nm) than the optical signal (e.g., 1530-1560 nm) the optical signal is further amplified via stimulated Raman scattering to produce an amplified optical signal. The amplified signal passes through the WDM 50, and is input the SOA 20 where it is further amplified and transmitted to the second optical isolator 30. The resulting doubly amplified output optical signal 65 is output the amplifier. Preferably, the input power to the Raman amplifying stage should not be high enough to cause severe non-linearity in the transmission fiber, but should be high enough to maintain moderate intensity at the input of the SOA 20.

FIG. 3 illustrates the individual gain spectra of each of the aforementioned SOA and Raman amplifying stages when the SOA is a polarization insensitive SOA having a gain peak at 1510 nm, and the Raman amplifying stage includes a 100 km of non-zero dispersion shifted fibre (NZDSF) counter-pumped at 1455 nm with 300 mW. In this embodiment the single Raman pump source 60 is a polarization combination of two semiconductor lasers with a maximum total power of 300 mW, however, polarization sensitivity can also be addressed with a depolarized, or polarization-scrambled, Raman pump source. The optical signal is provided by a flat and uniform 36-channel C-band DWDM source with 100 GHz spacing and wavelengths from 1530.33 nm to 1558.98 nm followed by an external modulator.

More specifically, FIG. 3 displays the gain spectra of the above SOA over the entire C-band, at different input signal power levels. For small input signal levels, such as 10 and −20 dBm, each gain spectra closely resembles a straight line with a negative gain tilt of about 5 dB. As the input signal level is increased, the tilt is reduced. For example, for an input signal power of about 5 dBm, the SOA is shown having reached a saturation state and producing substantially no gain tilt.

Similarly, the Raman gain spectrum is shown as a relatively smooth and straight curve over the entire C-band region with a positive gain tilt of about 5 dB, and a gain peak about 1555 nm. Notably, the positive gain tilt provided by the Raman amplifying stage is of the same magnitude, but opposite sign, as the negative gain tilt provided by the SOA when the input power is selected so as to operate in non-saturated operating conditions (eg., −20 to 5 dBm).

In accordance with the instant invention, the positive gain tilt of the Raman amplifying stage and the negative gain tilt of the SOA, provided in each embodiment of the hybrid amplifying schemes above, compensate one another to provide a relatively flat gain spectrum over the wavelength range of interest (e.g., the C band).

Advantageously, the distributed Raman amplifying stage also extends the span length of the optical amplification scheme by amplifying the signal channels while they are in the transmission fiber, and significant improves the signal-spontaneous beat noise performance.

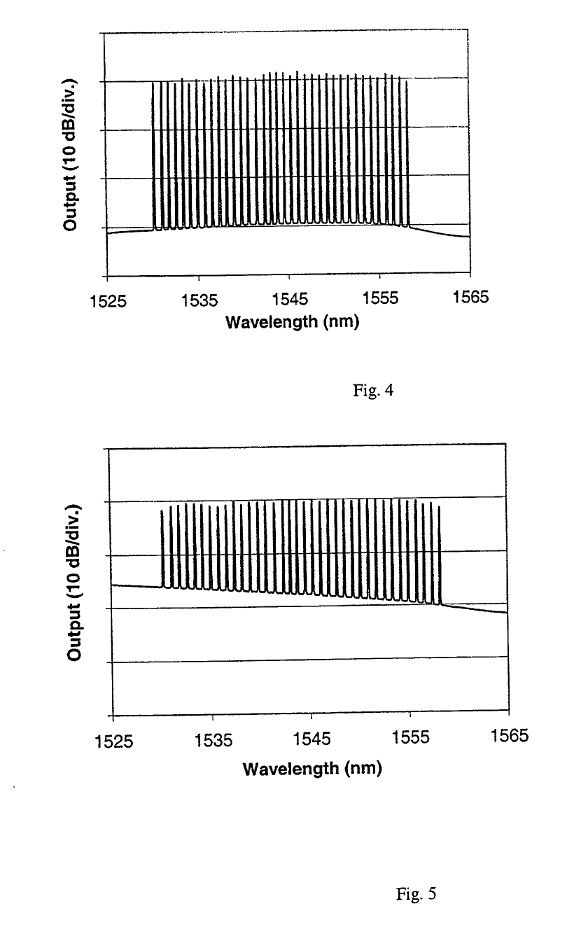

Referring to FIGS. 4 and 5, there is shown the doubly amplified output signal from the above embodiments, where the input power was about −5 dBm. More specifically, FIG. 4 shows the spectrum of the amplified output signal for the embodiment shown in FIG. 1, whereas FIG. 5 shows the spectrum of the amplified output signal for the embodiment shown in FIG. 2. In each case, a substantially flat spectrum was observed over the entire C-band. Notably, the substantially flat response corresponds to flatness about 1.5 dB. However, it is also worth noting that a better signal-to-noise performance is obtained from the embodiment shown in FIG. 1, wherein the SOA is upstream from the Raman amplification stage. Moreover, the amplified spontaneous emission (ASE) is lower and flatter for the embodiment shown in FIG. 1.

This higher performance of the first embodiment is believed to result from the different input powers to the SOA. For example, if the SOA precedes the Raman amplification stage, then the input power remains about −5 dBm, whereas if the Raman amplification stage precedes the SOA, then the input power for the SOA is much lower.

More specifically, when the Raman amplification stage precedes the SOA, the Raman gain, which on average is about 8 dB, does not compensate fiber loss, which is on average about 21 dB. Accordingly, the input to the SOA is typically less than −15 dBm, the ASE generated from the SOA is much higher, and the resulting signal-to-noise ratio is lower.

Advantageously, the amplifying scheme provided by the instant invention allows for easy upgrades of existing systems and extends the distance between amplifiers.

Moreover, a substantially flat gain over more than 30 nm is achievable without using pre-emphasis or gain equalizers. Advantageously, the hybrid amplifying scheme provides a wider bandwidth than achievable with a SOA alone.

Moreover, the optical amplifiers in accordance with the instant invention are suitable for wavelength regions outside the C-band. More specifically, a multiplexed optical signal within any wavelength range can be amplified if a suitable SOA and Raman pump wavelength are selected.

The embodiments of the invention described above are intended to be exemplary only. Of course, numerous other embodiments may be envisaged without departing from the spirit and scope of the invention.

For example, in one embodiment, the hybrid amplifier scheme shown in FIGS. 1 and 2, is cascaded with a similar amplifying scheme to further improve signal-to-noise ratios.

With reference to the embodiment shown in FIG. 1, this optionally includes coupling the SOA from the second scheme with the Raman pump/WDM from the first scheme, in a single module.

In another embodiment, a co-pumped or dual pumped Raman source replaces the single counter-pumped Raman source. However, the latter embodiment obviates the advantage of the instant invention over conventional Raman amplifiers, in that it provides exceptional results with only one Raman pump source.

Notably, the gain tilt of the SOA may be adjusted by varying the driving current of the SOA at a fixed input power, rather than varying the input power at a fixed driving current as shown in FIG. 3.

What is claimed is:

1. A method of amplifying an optical signal comprising the steps of:
launching the optical signal into an input port of a semiconductor optical amplifier such that an amplified output optical signal having a spectrum with a substantially negative slope within a predetermined wavelength range is produced at an output port of the semiconductor optical amplifier; and
pumping the amplified output optical signal with a wavelength and power sufficient to further amplify the amplified output signal via stimulated Raman scattering to produce a further amplified output optical signal having a substantially flat spectrum within the predetermined wavelength range.

2. A method according to claim 1, wherein the optical signal comprises a plurality of DWDM channels over the predetermined wavelength range, the predetermined wavelength range corresponding to a bandwidth of at least 30 nm.

3. A method according to claim 1, wherein the optical signal has an input power selected such that the semiconductor optical amplifier is not saturated.

4. A method according to claim 1, wherein the optical signal comprises a plurality of DWDM channels in the C-band, the optical signal has an input power selected between about −20 and −5 dBm, the wavelength is about 1455 nm, and the power is about 300 to 350 mW.

5. A method according to claim 1, wherein the step of pumping the amplified output optical signal comprises at least one of counter and co-pumping.

6. A method according to claim 1, further comprising the steps of:
launching the further amplified output optical signal into an input port of a second semiconductor optical amplifier to produce another amplified output optical signal having a spectrum with a negative slope; and
pumping the other amplified output optical signal with the wavelength and power sufficient to further amplify the other amplified output signal via stimulated Raman scattering to produce another further amplified output optical signal having a spectrum with a substantially flat slope.

7. A method of amplifying an optical signal comprising the steps of:
launching the optical signal along an optical fibre;
pumping the optical signal with a wavelength and a power sufficient to amplify the optical signal via stimulated Raman scattering to produce an amplified output optical signal having a spectrum with a substantially positive slope within a predetermined wavelength range; and,
launching the amplified output optical signal into an input port of a semiconductor optical amplifier such that a further amplified output optical signal is produced at an output port of the semiconductor optical amplifier having a substantially flat spectrum within the predetermined wavelength range.

8. A method according to claim 7, wherein the optical signal comprises a plurality of DWDM channels over the predetermined wavelength range, the predetermined wavelength range corresponding to a bandwidth of at least 30 nm.

9. A method according to claim 7, wherein the optical signal has an input power selected to obviate severe non-linearity in the optical fiber and to provide moderate intensity at the input port of the semiconductor optical amplifier.

10. A method according to claim 7, wherein the optical signal comprises a plurality of DWDM channels in the C-band, the optical signal has an input power selected between about −20 and −5 dBm, the wavelength is about 1455 nm, and the power is about 300 to 350 mW.

11. An apparatus for amplifying an optical signal comprising:
a semiconductor optical amplifier for producing an output optical signal having a substantially negatively sloped spectrum in response to an input optical signal having a substantially flat input spectrum; and
a Raman amplifier for producing another output optical signal having a substantially positively sloped spectrum in response to the input optical signal having the substantially flat input spectrum.

12. An apparatus according to claim 11, wherein the Raman amplifier is disposed one of upstream and downstream from the semiconductor optical amplifier.

13. An apparatus according to claim 12, wherein the Raman amplifier comprises a distributed Raman amplifier having a single pump source and a WDM for directing pump light from the single pump source in a counter-propagating direction.

14. An apparatus according to claim 13, wherein the single pump source is polarization insensitive.

15. An apparatus according to claim 13, wherein the semiconductor optical amplifier is polarization insensitive.

16. An apparatus according to claim 13, wherein a power of the input optical signal, and a power and a wavelength of the single pump source, are selected such that an input signal having a substantially flat input spectrum input into the apparatus for amplifying the optical signal is output an amplified output signal having a substantially flat output response.

17. An apparatus according to claim 11, wherein the semiconductor optical amplifier is upstream from the Raman amplifier.

18. An apparatus according to claim 17, comprising a first optical isolator upstream from the semiconductor optical amplifier for preventing backwards propagating light from reaching an input source, and a second optical isolator downstream from the semiconductor optical amplifier for preventing backwards propagating light from reaching the semiconductor amplifier.

19. An apparatus according to claim 11, wherein the semiconductor optical amplifier is downstream from the Raman amplifier.

20. An apparatus according to claim 19, comprising a first optical isolator upstream from the Raman amplifier for preventing backwards propagating light from reaching an input source, and a second optical isolator downstream from the semiconductor optical amplifier for preventing backwards propagating light from reaching the semiconductor amplifier.
